(19) United States
(12) Patent Application Publication
(10) Pub. No.: US 2008/0123018 A1
(43) Pub. Date: May 29, 2008

(54) LIGHT DIFFUSER PLATE, SURFACE LIGHT SOURCE DEVICE AND LIQUID CRYSTAL DISPLAY APPARATUS

(75) Inventors: Gihwan AHN, Niihama-shi (JP); Akiyoshi Kanemitsu, Niihama-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED, Tokyo (JP)

(21) Appl. No.: 11/939,802

(22) Filed: Nov. 14, 2007

(30) Foreign Application Priority Data
Nov. 15, 2006 (JP) 2006-308656

(51) Int. Cl. G02F 1/13357; F21V 7/00; F21V 7/04

(52) U.S. Cl. 349/64; 362/339; 362/246

(57) ABSTRACT

The present invention provides a light diffuser plate capable of emitting light with high uniformity in luminance.

A light diffuser plate 3 of the present invention has a relief structure section 4 consisting of a plurality of triangular ridges having a triangular cross section disposed on at least one side thereof, wherein the relief structure section 4 comprises first triangular ridges 6 of an isosceles triangular shape having a vertex angle α of 50 to 70 degrees and second triangular ridges 8 of an isosceles triangular shape having a vertex angle β of 110 to 130 degrees.

### BACKGROUND OF THE INVENTION

1. Technical Field

The present invention relates to a light diffuser plate and a surface light source device with high uniformity in luminance, and a liquid crystal display apparatus capable of showing pictures with high uniformity in luminance.

2. Description of the Related Art

Such a liquid crystal display apparatus is known, for example, that has a surface light source device as the backlight disposed on the back side of a display device comprising a liquid crystal cell and a pair of polarizers disposed on the front and back sides of the liquid crystal cell. For the surface light source device used as the backlight, such a constitution is known as a plurality of light sources are disposed in a lamp box, and a light diffuser plate is disposed on the front side of the light sources (refer to Japanese Unexamined Patent Publication (Kokai) No. 7-141908 (paragraph [0012], FIG. 1)). The surface light source device is required to be highly uniform in luminance.

The distance between adjacent light sources of the surface light source device is preferably as large as possible in order to reduce the number of light sources and thereby decrease energy consumption. The distance between the light sources and the light diffuser plate is preferably as small as possible in order to reduce the depth of the liquid crystal display apparatus.

In the surface light source device of the prior art, however, setting a larger distance between the light sources adjacent to each other or a smaller distance between the light source and the light diffuser plate makes it difficult to sufficiently diffuse the light emitted by the plurality of light sources by means of the light diffuser plate, thus resulting in a problem of poor uniformity in luminance.

### SUMMARY OF THE INVENTION

The present invention has been made with the background described above, and an object thereof is to provide a light diffuser plate and a surface light source device capable of emitting light with high uniformity in luminance. Another object of the present invention is to provide a liquid crystal display apparatus capable of showing high-quality pictures with high uniformity in luminance.

In order to achieve the objects described above, the present invention provides the following means.

[1] A light diffuser plate which comprises a light transmitting plate having a relief structure section consisting of a plurality of triangular ridges having a triangular cross section disposed on at least one side thereof, wherein the relief structure section comprises first triangular ridges of an isosceles triangular shape having a vertex angle of 50 to 70 degrees and second triangular ridges of an isosceles triangular shape having a vertex angle of 110 to 130 degrees.

### [2] The light diffuser plate according to [1], wherein the length of the base side of the first triangular ridge is in a range from 30 to 500 μm, and the length of the base side of the second triangular ridge is in a range from 30 to 500 μm.

[3] The light diffuser plate according to [1] or [2], wherein the total area S1 occupied by the first triangular ridges of the light diffuser plate in projected plan and the total area S2 occupied by the second triangular ridges of the light diffuser plate in projected plan are related by a ratio that is in a range from S1:S2=4:6 to 8:2.
[4] A surface light source device comprising the light diffuser plate according to any one of [1] to [3] and a plurality of light sources disposed on the back side of the light diffuser plate, wherein the surface whereon the relief structure section is formed is disposed on the front side of the light diffuser plate.
[5] A liquid crystal display apparatus comprising the light diffuser plate according to any one of [1] to [3], a plurality of light sources disposed on the back side of the light diffuser plate and a liquid crystal panel disposed on the front side of the light diffuser plate, wherein the surface whereon the relief structure section is formed is disposed on the front side of the light diffuser plate.

The light diffuser plate of the present invention according to [1] has the relief structure section consisting of a plurality of triangular ridges of triangular cross section disposed on at least one side thereof, while the relief structure section comprises the first triangular ridges of an isosceles triangular shape having a vertex angle of 50 to 70 degrees and the second triangular ridges of an isosceles triangular shape having a vertex angle of 110 to 130 degrees, and therefore light can be emitted with high uniformity in luminance.

According to the present invention according to [2], since the length of the base side of the first triangular ridge is in a range from 30 to 500 μm, and the length of the base side of the second triangular ridge is in a range from 30 to 500 μm, the relief structure section is not visible and high uniformity in luminance can be sufficiently obtained.

According to the present invention according to [3], since the area S1 occupied by the first triangular ridges of the light diffuser plate in projected plan and the area S2 occupied by the second triangular ridges of the light diffuser plate in projected plan are related by a ratio in a range from S1:S2=4:6 to 8:2, high uniformity in luminance can be sufficiently obtained.

According to the present invention according to [4], since the surface light source device comprises the light diffuser plate according to any one of [1] to [3] and the plurality of light sources disposed on the back side of the light diffuser plate, and the surface whereon the relief structure section is formed is disposed on the front side of the light diffuser plate, it is provided a surface device with high uniformity in luminance.

According to the present invention according to [5], a liquid crystal display apparatus capable of showing high-quality pictures with high uniformity in luminance can be provided.

### BRIEF DESCRIPTION OF THE DRAWINGS

FIG. 1 schematically shows one embodiment of the liquid crystal display apparatus according to the present invention.

FIG. 2 is a perspective view showing one embodiment of the light diffuser plate according to the present invention.

FIG. 3 is a sectional view of the light diffuser plate shown in FIG. 2.

FIG. 4 is a sectional view showing another embodiment of the light diffuser plate according to the present invention.

FIG. 5 is a sectional view showing further another embodiment of the light diffuser plate according to the present invention.

### BRIEF DESCRIPTION OF THE REFERENCE SYMBOLS

1 Surface light source device
2 Light source
3 Light diffuser plate
3a Back surface (The surface whereon the relief structure section is not formed)
3b Front surface (The surface whereon the relief structure section is formed)
4 Matted surface section
6 First triangular ridge
8 Second triangular ridge
20 Liquid crystal panel
30 Liquid crystal display apparatus
α Vertex angle of first triangular ridge
β Vertex angle of second triangular ridge
E1 Length of base side of first triangular ridge
E2 Length of base side of second triangular ridge

### DETAILED DESCRIPTION OF THE INVENTION

One embodiment of a liquid crystal display apparatus of the present invention is shown in FIG. 1. In FIG. 1, reference numeral (30) denotes the liquid crystal display apparatus, (11) denotes a liquid crystal cell, (12) and (13) denote polarizers and (1) denotes a surface light source device (backlight). The polarizers (12) and (13) are disposed on the front and back sides of the liquid crystal cell (11), so that the components (11), (12) and (13) constitute a liquid crystal panel (20) as a display device.

The surface light source device (1) is disposed on the back side of the back side polarizer (13) disposed on the back side of the liquid crystal panel (20). The surface light source device (1) comprises a lamp box (5) of flat box configuration having a rectangular shape in projected plan that is open on the front side, a plurality of linear light sources (2) disposed at a distance from each other in the lamp box (5), and a light diffuser plate (3) disposed on the front side of the plurality of linear light sources (2). The light diffuser plate (3) is mounted on the lamp box (5) so as to close the aperture thereof. The lamp box (5) is also lined with a reflecting layer (not shown) on the inside thereof.

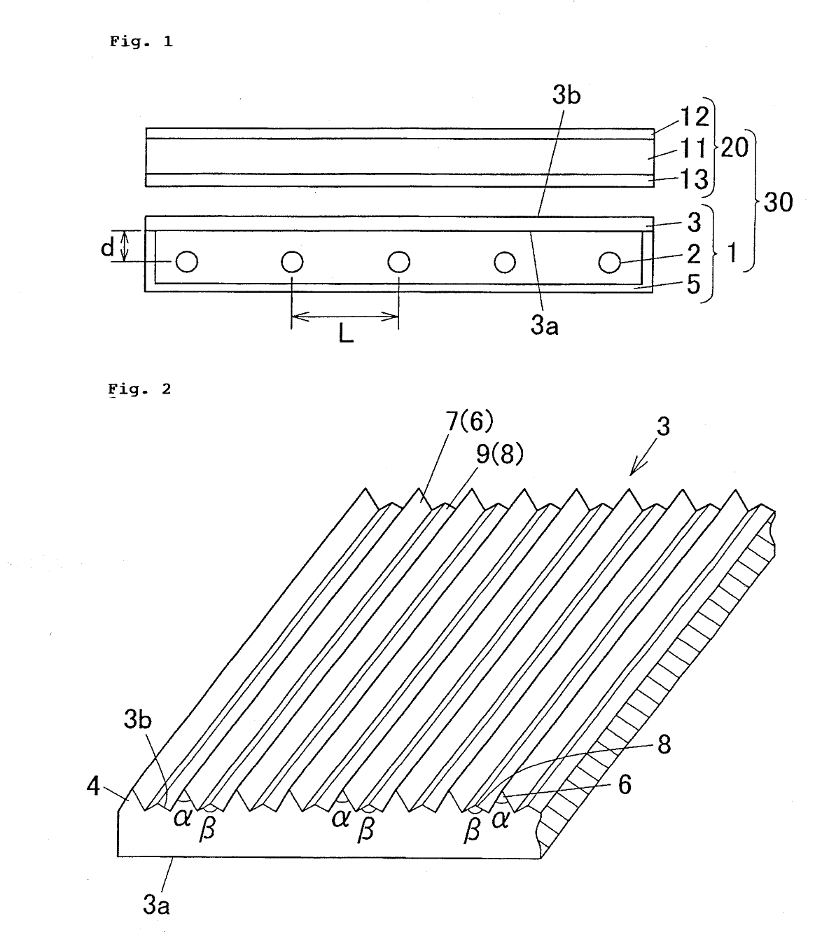

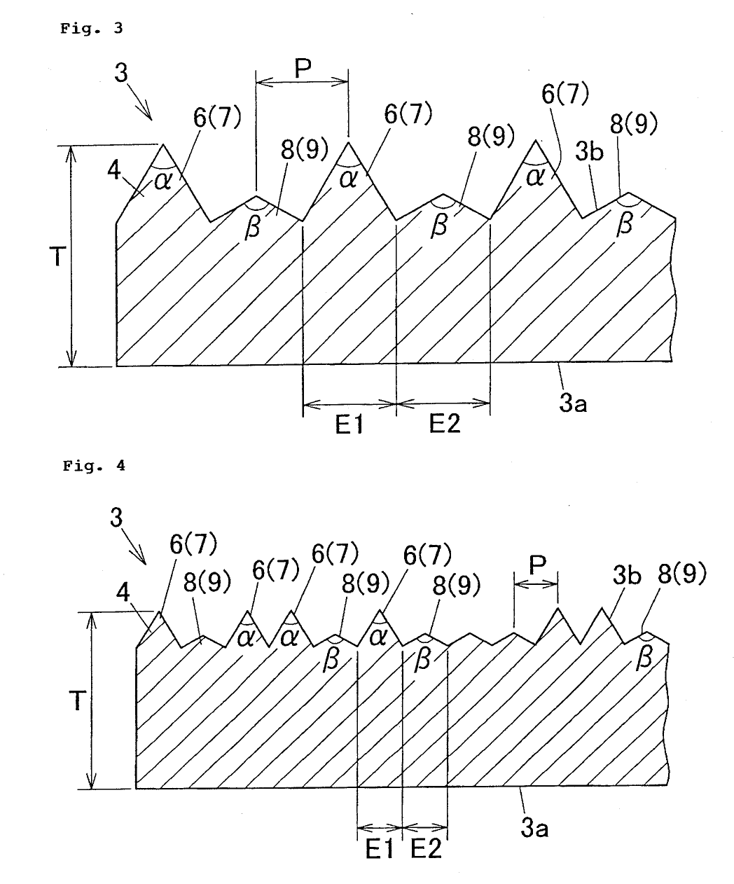

The light diffuser plate (3) has a relief structure section (4) consisting of a plurality of triangular ridges having a triangular cross section disposed on one side thereof as shown in FIGS. 2 and 3. The relief structure section (4) comprises a first triangular ridge (6) of an isosceles triangular shape having a vertex angle (α) of 50 to 70 degrees and a second triangular ridge (8) of an isosceles triangular shape having a vertex angle (β) of 110 to 130 degrees. In this embodiment, the first triangular ridge (6) and the second triangular ridge (8) are disposed alternately.

The light diffuser plate (3) is disposed so that a surface (3b) of the light diffuser plate (3) whereon the relief structure section (4) is formed is located on the front side, namely on the liquid crystal panel side (refer to FIG. 1). That is, the light diffuser plate (3) is disposed so that the surface (3a) whereon the relief structure section (4) is not formed is located on the back side (on the light source side) (refer to FIG. 1).

In this embodiment, a length (E1) of the base side of the first triangular ridge (6) is set equal to a length (E2) of the base side of the second triangular ridge (8) (refer to FIG. 3). Also, in this embodiment, the base side of the first triangular ridge (6) and the base side of the second triangular ridge (8) are disposed so as to be parallel to each other and lie in the same plane (refer to FIG. 3).

Also, in this embodiment, the first triangular ridge (6) is constituted from a ridge (7) having an isosceles triangle cross sectional shape formed on the surface of the light diffuser plate (3) to extend in one direction parallel to the surface of the light diffuser plate (3), and the second triangular ridge (8) is constituted from a ridge (9) having an isosceles triangle cross sectional shape formed on the surface of the light diffuser plate (3) extending in one direction parallel to the surface of the light diffuser plate (3), so that a plurality of ridges (7) and (9) run substantially parallel to each other (refer to FIG. 2).

In this embodiment, linear light sources are used as the light sources (2) and are disposed so that the longitudinal direction of the linear light sources (2) and the longitudinal direction of the plurality of ridges (7) and (9) of the light diffuser plate (3) substantially agree.

In the surface light source device (1) having the constitution described above, the light diffuser plate (3) has the relief structure section (4) consisting of a plurality of triangular ridges having a triangular cross section disposed on one side thereof, and the relief structure section (4) comprises the first triangular ridge (6) of an isosceles triangular shape having a vertex angle (α) of 50 to 70 degrees and the second triangular ridge (8) of an isosceles triangular shape having a vertex angle (β) of 110 to 130 degrees, so that uniform light can be emitted with high uniformity in luminance. In other words, the surface light source device (1) can emit light with high uniformity in luminance toward the liquid crystal panel (20). Also because the relief structure section (4) of the light diffuser plate (3) has an isosceles triangle cross sectional shape, the light diffuser plate (3) can be manufactured relatively easy with high productivity.

According to the present invention, while it is necessary that the relief structure section (4) has the first triangular ridges (6) of an isosceles triangular shape having a vertex angle (α) of 50 to 70 degrees and the second triangular ridges (8) of an isosceles triangular shape having a vertex angle (β) of 110 to 130 degrees, it is especially preferable to employ the following particular constitutions (first preferred embodiment and second preferred embodiment).

### FIRST PREFERRED EMBODIMENT

The relief structure section (4) has the first triangular ridges (6) of an isosceles triangular shape having a vertex angle (α) of 50.8 to 51.8 degrees and the second triangular ridges (8) of an isosceles triangular shape having a vertex angle (β) of 110.4 to 111.4 degrees. The first preferred embodiment is capable of sufficiently suppressing unevenness in luminance.

In the first preferred embodiment, a particularly preferable constitution is such that the relief structure section (4) has the first triangular ridges (6) of an isosceles triangular shape having a vertex angle (α) of 51.1 to 51.5 degrees and the second triangular ridges (8) of an isosceles triangular shape having a vertex angle (β) of 110.7 to 111.1 degrees.

### SECOND PREFERRED EMBODIMENT

The relief structure section (4) has the first triangular ridges (6) of an isosceles triangular shape having a vertex angle (α) of 68.8 to 69.8 degrees and the second triangular ridges (8) of an isosceles triangular shape having a vertex angle (β) of 128.8 to 129.8 degrees. The second preferred embodiment is capable of sufficiently suppressing the unevenness in luminance.

In the second preferred embodiment, a particularly preferable constitution is such that the relief structure section (4) has the first triangular ridges (6) of an isosceles triangular shape having a vertex angle (α) of 69.1 to 69.5 degrees and the second triangular ridges (8) of an isosceles triangular shape having a vertex angle (β) of 129.1 to 129.5 degrees.

According to the present invention, it is preferable that length (E1) of the base side of the first triangular ridge (6) is set in a range from 30 to 500 μm. A length not less than 30 μm brings the effect of suppressing the unevenness in luminance sufficiently, and a length not larger than 500 μm makes the relief structure section (4) invisible. It is particularly preferable to set the length (E1) of the base side of the first triangular ridge (6) in a range from 30 to 300 μm.

It is also preferable that the length (E2) of the base side of the second triangular ridge (8) is set in a range from 30 to 500 μm. A length not less than 30 μm brings the effect of suppressing the unevenness in luminance sufficiently, and a length not larger than 500 μm makes the relief structure section (4) invisible. It is particularly preferable to set the length (E2) of the base side of the second triangular ridge (8) in a range from 30 to 300 μm.

It is preferable that a space (P) between adjacent triangular ridges is set in a range from 30 to 500 μm. A space not less than 30 μm makes it easy to form the triangular ridges on the surface of the light diffuser plate, and a space not larger than 500 μm makes it possible to sufficiently suppress the unevenness in luminance while keeping the relief structure section (4) invisible.

While there is no restriction on a thickness (T) of the light diffuser plate (3), T is preferably set in a range from 0.2 to 10.0 mm. When the thickness is set within this range, it is made possible to further decrease the depth of the apparatus while sufficiently suppressing the unevenness in luminance. It is particularly preferable to set the thickness (T) of the light diffuser plate (3) in a range from 0.5 to 5.0 mm.

While there is no restriction on the method of manufacturing the light diffuser plate (3), for example, extrusion molding, press molding, a machining process, injection molding or the like may be employed. Among these, extrusion molding is preferably employed for the reason of manufacturing efficiency.

When manufacturing the light diffuser plate (3) by extrusion molding or press molding, a mold having a pattern of prisms of triangular cross section embossed thereon may be used to replicate the prism pattern onto the surface of the light diffuser plate (3). In this case, the fidelity is preferably 70% or higher, and more preferably 85% or higher. The fidelity is calculated by the following equation.

Fidelity (%)=H2/H1×100

where H1 is the height of the triangular ridges formed on the mold and H2 is the height of the triangular ridges formed on the resultant light diffuser plate.

There is no restriction on the material used to form the light diffuser plate (3), and any material may be used as long as it is transparent. For example, a glass sheet, an optical glass sheet or a transparent resin sheet may be used. As the transparent resin sheet, for example, an acrylic resin sheet, a polycarbonate resin sheet, a polystyrene sheet, a cycloolefin resin sheet, a MS resin sheet (a methyl methacrylate-styrene copolymer sheet), an ABS resin sheet, and an AS resin sheet (an acrylonitryl-styrene copolymer sheet) may be used. It is preferable to use a transparent sheet having a refractive index of 1.45 to 1.60.

The light diffuser plate (3) of the present invention is given the light diffusing function by forming the matted surface section (4) on at least one of the surfaces thereof. However, the material of the light diffuser plate (4) may also be caused to have the light diffusing function, so as to complement the light diffusing function of the relief structure section (4). For example, the light diffuser plate (3) may be prepared by forming a composition in which light diffusing particles such as polystyrene particles, silicone particles, or inorganic particles such as calcium carbonate particles, barium sulfide particles, titanium oxide particles or alumina particles, are included in a transparent resin such as an acrylic resin. Also, the light diffuser plate may be formed from an acrylic resin including particles having anisotropy in refractive index contained therein while being aligned.

While there is no restriction on the light sources (2), a point light source such as a light emitting diode may be used as well as a linear light source such as a fluorescent lamp, a halogen lamp or a tungsten lamp.

A distance (L) between adjacent light sources (2), (2) is preferably set to less than 20 mm in order to ensure uniform luminance. A distance (d) between the light sources (2) and the light diffuser plate (3) is preferably set to 15 mm or larger in order to ensure uniform luminance.

In the embodiments shown in FIGS. 1 through 3, the triangular ridges (6), (8) of the light diffuser plate comprise the ridges (7), (9), respectively, extending in one direction parallel to the surface thereof (one dimensional type) (refer to FIG. 2). However, the present invention is not limited to this constitution, and the triangular ridges (6), (8) of the light diffuser plate may also comprise the ridges (7), (9), respectively, extending in two different directions (for example, two directions perpendicular to each other) parallel to the surface thereof (two dimensional type).

While the first triangular ridges (6) and the second triangular ridges (8) are disposed alternately in the embodiment described above (refer to FIG. 3), the present invention is not limited to this constitution, and the first triangular ridge (6) and the second triangular ridge (8) may also be disposed in a random arrangement, for example, as shown in FIG. 4.

In the embodiment described above, although the length (E1) of the base side of the first triangular ridge (6) is set equal to the length (E2) of the base side of the second triangular ridge (8) (refer to FIG. 3), the present invention is not limited to this constitution, and such a constitution as E1 and E2 having different values may also be employed.

Also, in the embodiment described above, the total area S1 occupied by the first triangular ridges (6) of the light diffuser plate in projected plan and the total area S2 occupied by the second triangular ridges (8) of the light diffuser plate in projected plan are set to be equal to each other (S1=S2). However, there is no restriction on the ratio of S1 and S2, as long as the effect of the present invention is not adversely affected. In order to achieve a sufficient effect of suppressing the unevenness in luminance, the ratio is preferably in a range from S1:S2=4:6 to 8:2.

Also, in this embodiment, the base side of the first triangular ridge (6) and the base side of the second triangular ridge (8) are disposed parallel to each other and lie in the same plane (refer to FIG. 3). However, the present invention is not limited to this constitution, and such a constitution may also be employed as, for example, the base sides of both triangular ridges are disposed parallel to each other but do not lie in the same plane, or the base sides of both triangular ridges are not parallel to each other.

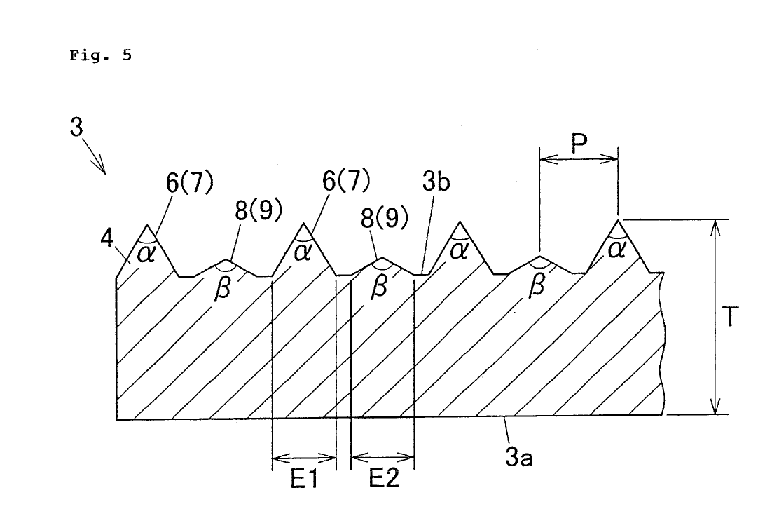

In the embodiment described above, although the adjacent triangular ridges (6), (8) are disposed consecutively, the present invention is not limited to this constitution as long as the effect of the present invention is not adversely affected. For example, there may be a flat surface disposed between the adjacent triangular ridges (6), (8) as shown in FIG. 5.

The relief structure section (4) may be constituted from triangular ridges other than the first triangular ridges (6) of an isosceles triangular shape having a vertex angle (α) in a range from 50 to 70 degrees and the second triangular ridges (8) of an isosceles triangular shape having a vertex angle (β) in a range from 110 to 130 degrees, and such a constitution may be employed that, for example, includes triangular ridges of an isosceles triangular shape having a vertex angle larger than 0 degrees and less than 50 degrees or larger than 130 degrees and less than 180 degrees, triangular ridges having a non-isosceles triangular shape, etc., as long as the effect of the present invention is not adversely affected.

The light diffuser plate (3), the surface light source device (1) and the liquid crystal display apparatus (30) of the present invention are not limited to those of the embodiments described above, and any modifications within the scope of the claims may be made without deviating from the spirit of the invention.

### EXAMPLES

Examples of the present invention will now be described, but the present invention is not limited to the following Examples.

### Example 1

100 parts by weight of a MS resin (a methyl methacrylate-styrene copolymer resin, refractive index 1.57) and 2.2 parts by weight of polymethyl methacrylate particles having a volume average particle size of 4.3 μm (“MBX-5” manufactured by Sekisui Plastic Co., Ltd.) used as the light diffusing particles were mixed in a Henschel mixer, and the mixture was melted, kneaded and formed into a plate by an extrusion molding machine. The plate was subjected to thermal pressing by using a mold having a desired pattern to be replicated, thereby making the light diffuser plate (3) of the constitution shown in FIGS. 2 and 3. The light diffuser plate (3) was 2 mm in thickness (T) and had the first triangular ridges (6) of an isosceles triangular shape having a vertex angle (α) of 51.3 degrees and the second triangular ridges (8) of an isosceles triangular shape having a vertex angle (β) of 110.9 degrees disposed alternately on one side thereof, wherein the length (E1) of the base side of the first triangular ridge (6) was 60 μm, the length (E2) of the base side of the second triangular ridge (8) was 60 μm, and the space (P) between adjacent triangular ridges was 60 μm (refer to FIG. 3). The base side of the first triangular ridge (6) and the base side of the second triangular ridge (8) were disposed so as to be parallel to each other and lie in the same plane (refer to FIG. 3).

The surface light source device (1) of the constitution shown in FIG. 1 was made by using the light diffuser plate (3). Fluorescent lamps were used for the light sources (2), while setting the distance (d) between the light diffuser plate (3) and the light sources (2) to 20.0 mm and the distance (L) between adjacent light sources (2), (2) to 30.0 mm.

### Comparative Example 1

100 parts by weight of a MS resin (methyl methacrylate-styrene copolymer resin, refractive index 1.57) and 3.1 parts by weight of polymethyl methacrylate particles having a volume average particle size of 4.3 μm (“MBX-5” manufactured by Sekisui Plastic Co., Ltd.) used as the light diffusing particles were mixed in a Henschel mixer, and the mixture was melted, kneaded and formed into a plate by an extrusion molding machine. The plate was subjected to thermal pressing by using a mold having a desired pattern to be replicated, thereby making the light diffuser plate (3) of the constitution shown in FIGS. 2 and 3. In the light diffuser plate of Comparative Example 1, the vertex angle of all triangular ridges was 90 degrees, length of the base side of the triangular ridges was 50 μm, and the space between adjacent triangular ridges was 50 μm.

The surface light source device of the constitution shown in FIG. 1 was made by using the light diffuser plate described above. Fluorescent lamps were used for the light sources, while setting the distance (d) between the light diffuser plate and the light sources to 20.0 mm and the distance (L) between adjacent light sources to 30.0 mm.

The surface light source devices made as described above were evaluated according to the following method. Results of evaluation are shown in Table 1.

### Measurement of Luminance and Evaluation of Uniformity of Luminance

The luminance of the surface light source device was measured and uniformity of luminance was checked by using a luminance meter (“Eye-Scale 3W, 4W” manufactured by I System Corporation). The luminance was determined by averaging the values over the entire light emitting surface of the surface light source device, and uniformity of luminance was calculated from a minimum value of luminance “C1” and a maximum value of luminance “C2” by the following equation.

Uniformity of luminance=C1/C2×100

TABLE 1

| | Constitution of light diffuser plate | | | | | |
|---|---|---|---|---|---|---|
| | First triangular | | Second triangular | | | |
| | ridge | | ridge | | Evaluation | |
| | Vertex | Length of | Vertex | Length | | Uniformity |
| | angle α | base side | angle β | of base side | Luminance | of |
| | (degree) | E1 (μm) | (degree) | E2 (μm) | (cd/m²) | luminance |
| Example 1 | 51.3 | 60 | 110.9 | 60 | 5190 | 93 |

| | | | |
|---|---|---|---|
| Comparative | Vertex angle of | 5210 | 89 |
| Example 1 | triangular ridges: 90 degrees, | | |
| | length of base side: 50 μm | | |

As will be clear from Table 1, the surface light source device of Example 1 of the present invention is capable of emitting light uniformly with high uniformity in luminance. The surface light source device of Comparative Example 1 that was out of the scope of the invention, in contrast, exhibited a significant unevenness in luminance.

The light diffuser plate of the present invention can be preferably used as the light diffuser plate for a surface light source device, but is not restricted to this application. The surface light source device of the present invention can be preferably used as the backlight for a liquid crystal display apparatus, but is not restricted to this application.

1. A light diffuser plate which comprises a light transmitting plate having a relief structure section consisting of a plurality of triangular ridges having a triangular cross section disposed on at least one side thereof, wherein the relief structure section comprises first triangular ridges of an isosceles triangular shape having a vertex angle of 50 to 70 degrees and second triangular ridges of an isosceles triangular shape having a vertex angle of 110 to 130 degrees.

2. The light diffuser plate according to claim 1, wherein the length of the base side of the first triangular ridge is in a range from 30 to 500 μm, and the length of the base side of the second triangular ridge is in a range from 30 to 500 μm.

3. The light diffuser plate according to claim 1, wherein the total area S1 occupied by the first triangular ridges of the light diffuser plate in projected plan and the total area S2 occupied by the second triangular ridges of the light diffuser plate in projected plan are related by a ratio that is in a range from S1:S2=4:6 to 8:2.

4. A surface light source device comprising the light diffuser plate according to claim 1 and a plurality of light sources disposed on the back side of the light diffuser plate, wherein the surface whereon the relief structure section is formed is disposed on the front side of the light diffuser plate.

5. A liquid crystal display apparatus comprising the light diffuser plate according to claim 1, a plurality of light sources disposed on the back side of the light diffuser plate and a liquid crystal panel disposed on the front side of the light diffuser plate, wherein the surface whereon the relief structure section is formed is disposed on the front side of the light diffuser plate.
